(19) United States
(12) Patent Application Publication
(10) Pub. No.: US 2010/0277916 A1
(43) Pub. Date: Nov. 4, 2010

(54) LED Light Module and Modular Lighting System

(76) Inventor: Hiroshi Kira, Camarillo, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/432,569

(22) Filed: Apr. 29, 2009

(51) Int. Cl. F21V 29/00; F21V 21/00

(52) U.S. Cl. 362/249.02; 362/235; 362/294

(57) ABSTRACT

There is disclosed a light module including a first plurality of light emitting diodes (LEDs), a heat transfer surface and an electrical power plug. The plurality of LEDs may be disposed generally in a first circle to emit light radially outward from a central axis. The heat transfer surface may be thermally coupled to the plurality of LEDs. The electrical power plug may be electrically coupled to the plurality of LEDs.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to lamps.

2. Description of the Related Art

Light emitting diodes (LEDs) are widely used in a variety of colored lighting applications such as traffic signals and automotive stop lights and turn signals. With the development of high efficiency white-emitting LED devices, LED-based lighting is increasingly applied in other applications such as accent lighting, general illumination, arena lighting, and landscape and street lighting.

A primary benefit of LED-based lighting is efficiency. Recently developed white-emitting LED devices have power conversion efficiencies approaching 10 times the efficiency of incandescent lamps and comparable to the efficiency of fluorescent lamps and high intensity discharge lamps. LED lamps have a potential to provide even higher efficiency in the future. In addition, LEDs have very long life compared to incandescent lamps. For example, typical incandescent lamps have average lifetimes of a few thousand hours or less. High reliability LEDs may emit at least 90% of their original light output after 10,000 hours of use and may operate for 50,000 hours or longer.

A primary limitation of LEDs is that the power consumption, and consequentially the light output, of an individual LED is limited to about one watt with current technology. Thus many applications may require a plurality of LED devices to produce the desired light output.

### DESCRIPTION OF THE DRAWINGS

FIG. 1 is a perspective view of a modular lighting unit.

FIG. 2A is a side view of an LED module.

FIG. 2B is a partial cross-sectional view of a heat sink module.

FIG. 3 is a side view of an LED module.

FIG. 4 is a side view of an LED module.

FIG. 5 is a side view of an LED module.

FIG. 6 is a block diagram of a modular lighting unit.

Throughout this description, elements appearing in figures are assigned reference designators which are specific to the element and which remain constant if the element appears in multiple figures. An element that is not described in conjunction with a figure may be presumed to have the same characteristics and function as a previously-described element having the same reference designator.

### DETAILED DESCRIPTION

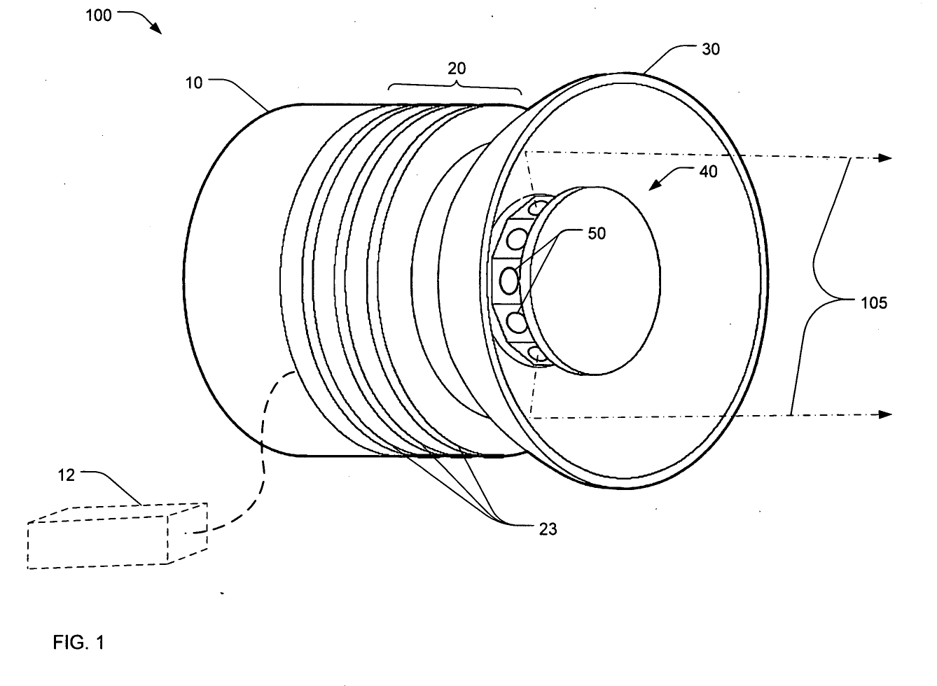

Referring now to FIG. 1, a modular lighting unit 100 may include a power converter module 10, a heat sink module 20, a reflector 30, and an LED light module 40. The light module 40 may be mechanically, electrically, and thermally coupled to the heat sink module 20. The reflector 30 may be partially enclosed in a reflector housing, not shown in FIG. 1, for environmental protection. The reflector 30 or the reflector housing may be mechanically coupled to either the heat sink module 20 or the light module 40. The heat sink module 20 may be mechanically and electrically coupled to the power converter module 10. Alternatively, the heat sink module 20 may be electrically coupled to an external power converter 12.

The power converter module 10 or the external power converter 12 may convert power from a primary power source into converted power suitable for powering the light module 40. For example, the power converter module 10 may accept 110 volt alternating current (AC) primary power and provide a low voltage direct current (DC) power to the light module 40. The power converter module 10 may be one of a family of power converter modules that may be interchangeable at least to the extent that any of the family of power converter modules may be coupled to the heat sink module 20. The family of power converter modules may include, for example, modules adapted to operate from different primary power sources and/or modules adapted to provide different DC power levels.

The heat sink module 20 may function to mechanically and electrically connect the power converter module 10 to the light module 40. The heat sink module 20 may receive heat generated in the light module 40. The heat sink module may conduct the received heat to one or more fins 23 which couple the heat to the ambient surrounding the heat sink module. The heat sink module 20 may be one of a family heat sink modules that may be interchangeable at least to the extent that any of the family of heat sink modules may be coupled to the light module 40 and the power converter module 10 or an external power converter 12. The family of heat sink modules may include, for example, modules with different numbers and sizes of fins adapted to couple different amounts of heat to the ambient.

The light module 40 may generate light using a plurality of light emitting diodes (LEDs) 50 that may be disposed to emit light generally radially outward from a central point. The LEDs 50 may generate heat in addition to light. The LEDs 50 may be coupled to receive converted electrical power from the power converter module 10 or the external power converter 12 via the heat sink module. The LEDs 50 may be thermally coupled to the heat sink module 20 such that at least a substantial portion of the heat generated in the LEDs 50 may be conducted to the heat sink module 20 and then coupled to the environment. Some portion of the heat generated in the LEDs 50 may also be coupled to the environment through external surfaces of the light module 40, the reflector 30, and the reflector housing (not shown). The light module 40 may be one of a family of light modules that may be interchangeable at least to the extent that any of the family of light modules may be coupled to the heat sink module 20. The family of light modules may include, for example, modules with different numbers and colors of LEDs.

The reflector 30 may redirect light emitted from the LEDs 50, as shown by representative light rays 105. The reflector 30 may be one of a family of reflectors that may be interchangeable at least to the extent that any of the family of reflectors may be coupled to the heat sink module 20 or the light module 40. The family of reflectors may include, for example, reflectors than form the light emitted by the LEDs 50 into a narrow spot beam, a wide spot beam, and a flood beam, respectively.

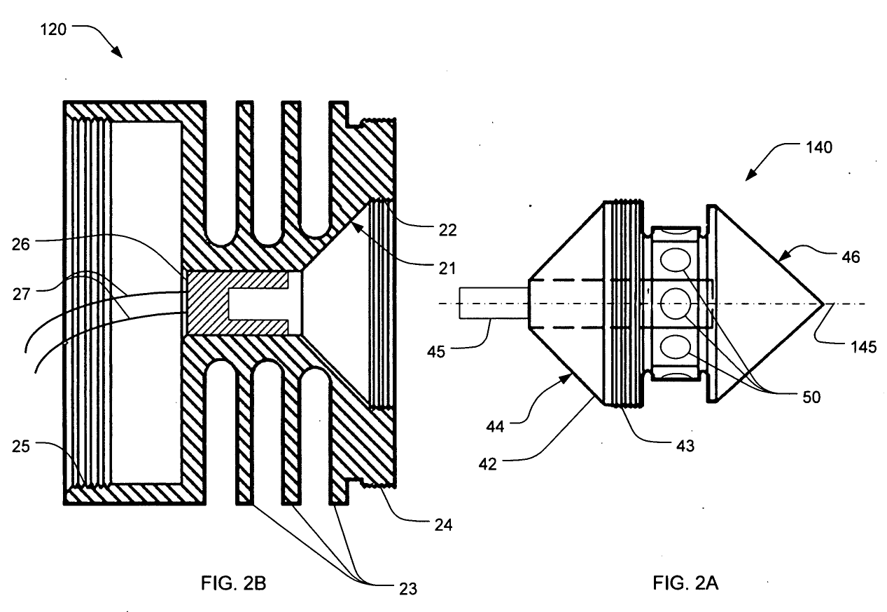

FIG. 2A shows a side view of a light module 140 which may be the light module 40 or a member of a family of light modules including the light module 40. The light module 140 may include a plurality of LEDs 50, which may be disposed in a first circle. In this context, “in a circle” means that a circle may be drawn through the plurality of LEDs and does not preclude the LEDs being disposed on the sides or vertices of a regular polygonal. In the specific example shown in FIG. 2A, the plurality of LEDs 50 may consist of 10 LEDs. Each of the ten LEDs may be disposed in the center of a corresponding rectangular facet which, in cross section, forms a regular decagon. The plurality of LEDs 50 may include fewer or more than 10 LEDs.

Each of the plurality of LEDs 50 may be oriented to emit light radially outward from the center of the first circle. It must be understood that the light emitted by a LED is not collimated but is distributed in an emission pattern that covers a finite angular range. Each of the plurality of LEDs 50 may be oriented such that the center of its emission pattern is directed outward from the center of the first circle. The center of the emission pattern of each of the plurality of LEDs 50 may be normal or oblique to an axis 145 of the light module 140.

Each of the plurality of LEDs 50 may generate heat in addition to light. The heat generated in each LED must be removed or the temperature of the LED may rise to a level that causes the LED to fail. The plurality of LEDs 50 may be mounted to or otherwise coupled to a body 42 of the light module 140. The body 42 may be formed of aluminum, copper, or some other heat conductive material. The body 42 may be effective to conduct heat generated in the plurality of LEDs 50 away from the LEDs.

The body 42 may have a heat transfer surface 44 which couples at least a substantial portion of the heat generated by the plurality of LEDs 50 to a mating heat receptor surface 21 of the heat sink module 120 shown in FIG. 2B. The light module 140 alone may not have sufficient surface area to effectively couple the heat generated by the plurality of LEDs 50 into an environment. Thus the light module 140 may not be safely operable unless coupled to a heat sink module such as the heat sink module 120. The heat transfer surface 44 may be a frustum, defined as a portion of a cone truncated by two parallel planes, concentric with the first circle.

An electrical power connector 45 may be disposed proximate the smaller end of the heat transfer surface 44. The electrical power connector 45 may extend, at least in part, from the smaller end of the frustum that forms the heat transfer surface 44. The electrical power connector 45 may be adapted to make two electrical connections with a mating electrical power receptacle 26 in the heat sink module 120. The electrical power connector 45 may include a cylindrical barrel and a center contact similar to the connectors commonly used on portable electronic equipment. The electrical power connector 45 may be configured such that the electric connections are maintained while the electric connector 45 is rotated axially within the mating electrical power receptacle 26. The electrical power connector 45 may be coaxial with the frustum and the first circle.

The light module 140 may contain provisions for mechanically connecting the light module 140 to a heat sink module such as the heat sink module 120. For example, the light module 140 may include an externally-threaded cylindrical section or barrel 43 proximate the large end of the heat transfer surface 44. The externally threaded barrel 43 may screw into a mating internally threaded barrel 22 of the heat sink module 120. The externally threaded barrel 43 may be coaxial with the heat transfer surface 44 and the electrical power connector 45. Similarly, the internally threaded barrel of the heat sink module may be coaxial with the heat receptor surface 21 and the electrical power receptacle 26. Thus the action of screwing the externally threaded barrel 43 into the internally threaded barrel 22 may urge the heat transfer surface 44 and the heat receptor surface 21 into intimate contact, while simultaneously mating the electrical power connector 45 with the electrical power receptacle 26. The transfer of heat from the light module heat transfer surface 44 to the heat sink module heat receptor surface 21 may be enhanced by the application of heat sink compound to one or both heat transfer surfaces 45, 21 before coupling the light module 140 to the heat sink module 120.

The light module 140 may include a generally conical cap 46 which may be primarily decorative or may, if mirrored, be effective to redirect a portion of the light emitted by the plurality of LEDs 50 and subsequently reflected from a reflector such as the reflector 50.

The heat sink module 120 may include an internally threaded barrel 25 to mechanically couple to a power converter module such as the power converter module 10. Other techniques for mechanically coupling a heat sink module and a power supply module may be used.

The heat sink module 120 may also include an externally threaded barrel 24 proximate to and coaxial with the heat receptor surface 21 to mechanically couple to a reflector such as the reflector 30.

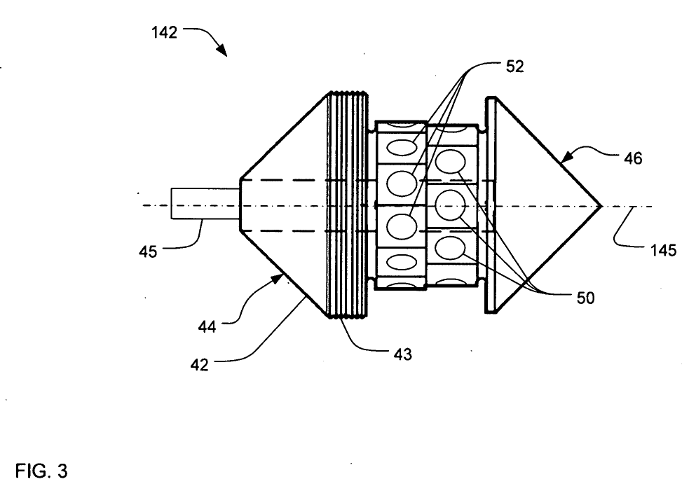

Referring now to FIG. 3, a light module 142 may be generally similar to the light module 140 with the exception that a second plurality of LEDs 52 may be disposed in a second circle. The second circle may or may not be coaxial with the first circle formed by the first plurality of LEDs 50. Each of the second plurality of LEDs 52 may be oriented to emit light radially outward from the center of the second circle. The second plurality of LEDs 52 may be electrically coupled to the electrical power plug 45 and thermally coupled to the heat transfer surface 44. The first plurality of LEDs 50 and the second plurality of LEDs 52 may emit light at different angles with respect to an axis 145 of the light module 142.

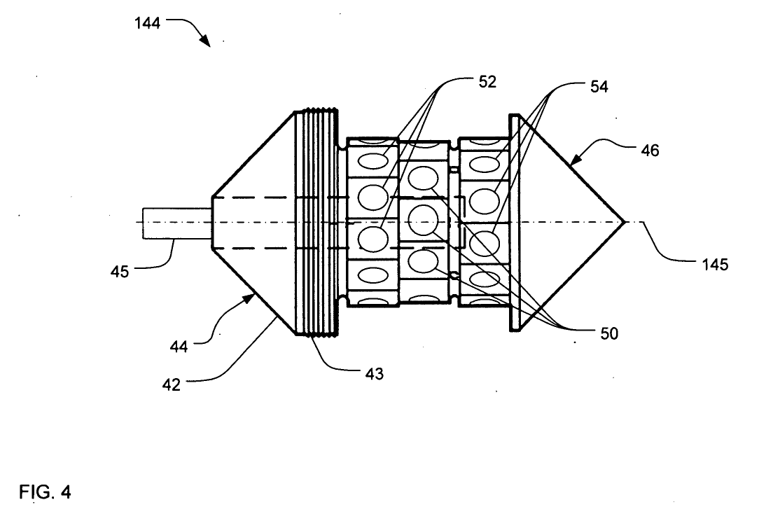

Referring now to FIG. 4, a light module 144 may be generally similar to the light module 140 with the exception that a second plurality of LEDs 52 may be disposed in a second circle and a third plurality of LEDs 54 may be disposed in a third circle. Both the second circle and the third circle may or may not be coaxial with the first circle formed by the first plurality of LEDs 50. Each of the second plurality of LEDs 52 and the third plurality of LEDs 54 may be oriented to emit light radially outward from the center of the respective circle. The first plurality of LEDs 50, the second plurality of LEDs 52, and the third plurality of LEDs 54 may emit light at different angles with respect to an axis 145 of the light module 144.

The second and third pluralities of LEDs 52, 54 may be electrically coupled to the electrical power plug 45 and thermally coupled to the heat transfer surface 44.

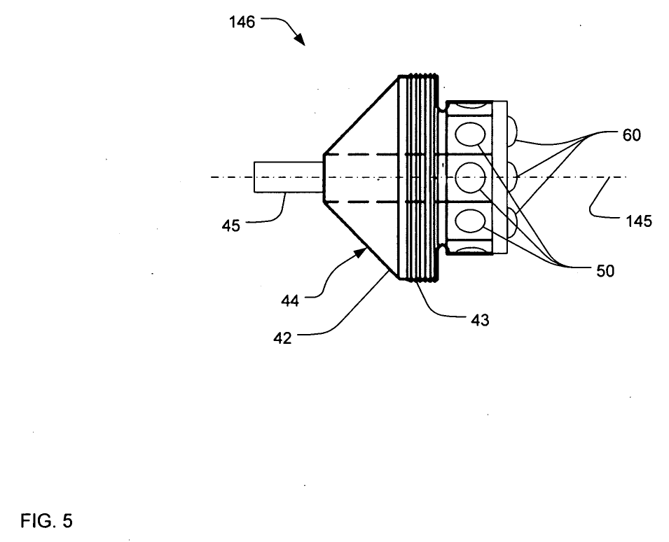

Referring now to FIG. 5, a light module 146 may be generally similar to the light module 140 with the exception that a fourth plurality of LEDs 60 may be disposed in a plane parallel to the first circle formed by the first plurality of LEDs 50. Each of the fourth plurality of LEDs 60 may be oriented to emit light axially. The fourth plurality of LEDs 60 may be electrically coupled to the electrical power plug 45 and thermally coupled to the heat transfer surface 44.

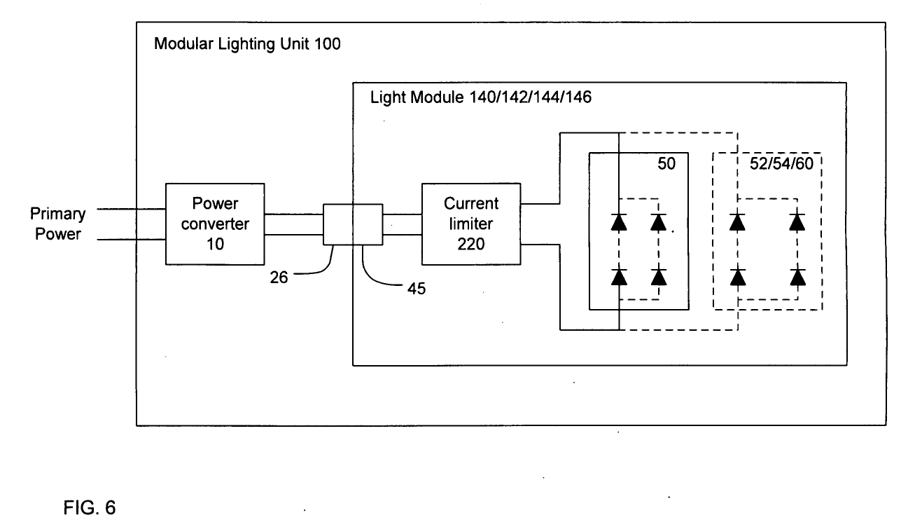

Referring now to FIG. 6, a modular lighting unit 100 may include a power converter module 10 and a light module which may be one of the light modules 140, 142, 144, or 146. The light module may include a first plurality of LEDs 50 and, optionally, additional pluralities of LEDs 52, 54, and/or 60. The LEDs 50, 52, 54, 60 may be electrically connected in series, in parallel, or in some combination of series and parallel. The light module may include an active or passive current limiter circuit 220 coupled between the power plug 45 and the LEDs 50, 52, 54, 60. The current limiter circuit 220 may be effective to limit the current drawn from the power converter module 10 to a value appropriate for the number of LEDs within the light module 140, 142, 144, 146.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A light module, comprising:
a first plurality of light emitting diodes (LEDs) disposed generally in a first circle to emit light radially outward from a central axis
a heat transfer surface thermally coupled to the plurality of LEDs
an electrical power plug electrically coupled to the plurality of LEDs.

2. The light module of claim 1, further comprising:
a second plurality of LEDs disposed generally in a second circle to emit light radially outward from the central axis.

3. The light module of claim 2, further comprising:
a third plurality of LEDs disposed generally in a third circle to emit light radially outward from the central axis.

4. The light module of claim 1, further comprising:
a fourth plurality of LEDs disposed to emit light in an axial direction.

5. The light module of claim 1, further comprising:
a current limiter coupled between the electrical power plug and the first plurality of LEDs.

6. The light module of claim 1, wherein the heat transfer surface is a frustum coaxial with the first circle.

7. The light module of claim 6, wherein
the electrical power plug has a generally cylindrical shape coaxial with the first circle
the electrical power plug extends from a smaller end of the heat transfer surface.

8. The light module of claim 1, further comprising
an externally threaded barrel coaxial with the heat transfer surface, wherein the externally threaded barrel is adapted to screw into an internally threaded portion of a heat sink module.

9. The light module of claim 8, wherein screwing the externally threaded barrel into the internally threaded portion of the heat sink module urges the heat transfer surface into intimate contact with a heat receptor surface of the heat sink module and causes the electrical power plug to engage with a mating electrical power receptacle.

10. A modular lighting unit, comprising:
a heat sink module electrically coupled to a power converter that converts primary electrical power into converted power for driving light emitting diodes (LEDs)
a light module electrically, mechanically, and thermally coupled to the heat sink module, the light module comprising
a first plurality of light emitting diodes (LEDs) disposed generally in a first circle to emit light radially outward from a central axis
a heat transfer surface thermally coupled to the plurality of LEDs, wherein the heat transfer surface is adapted to transfer heat generated in the first plurality of LEDs to the heat sink module,
an electrical power plug electrically coupled to the plurality of LEDs, wherein the electrical power plug is adapted to receive converted power from the power conversion module via the heat sink module
a reflector mechanically coupled to one of the heat sink module and the light module, wherein the reflector is adapted to receive and redirect the light emitted by the LEDs.

11. The modular lighting unit of claim 10, wherein the power converter is a power converter module mechanically coupled to the heat sink module.

12. The modular lighting unit of claim 10, further comprising:
a second plurality of LEDs disposed generally in a second circle to emit light radially outward from the central axis.

13. The modular lighting unit of claim 12, further comprising:
a third plurality of LEDs disposed generally in a third circle to emit light radially outward from the central axis.

14. The modular lighting unit of claim 10, further comprising:
a fourth plurality of LEDs disposed to emit light in an axial direction.

15. The modular lighting unit of claim 10, further comprising:
a current limiter coupled between the electrical power plug and the first plurality of LEDs.

16. A modular lighting system, comprising:
at least one power converter module to convert primary electrical power into converted power for driving light emitting diodes (LEDs)
a plurality of heat sink modules, wherein each heat sink module is adapted to electrically and mechanically couple to each power converter module
a plurality of light modules, wherein each light module is adapted to electrically, mechanically, and thermally coupled to each heat sink module, each light module comprising
a first plurality of light emitting diodes (LEDs) disposed generally in a first circle to emit light radially outward from a central axis
a heat transfer surface thermally coupled to the plurality of LEDs, wherein the heat transfer surface transfers heat generated in the first plurality of LEDs to the heat sink module,
an electrical power plug electrically coupled to the plurality of LEDs, wherein the electrical power plug receives converted power from the power conversion module via the heat sink module
a plurality of reflectors, each reflector adapted to mechanically couple to each of the heatsink modules, each reflector to receive and redirect the light emitted by the LEDs.

17. The modular lighting system of claim 16, further comprising:
a light module including a second plurality of LEDs disposed generally in a second circle to emit light radially outward from the central axis.

18. The modular lighting system of claim 16, further comprising:
a light module including a second plurality of LEDs disposed generally in a second circle to emit light radially outward from the central axis and a third plurality of LEDs disposed generally in a third circle to emit light radially outward from the central axis.

19. The modular lighting system of claim 16, further comprising:
a light module including a fourth plurality of LEDs disposed to emit light in an axial direction.

20. The modular lighting system of claim 16, each light module further comprising:
a current limiter coupled between the electrical power plug and the first plurality of LEDs.
